(19) United States
(12) Patent Application Publication
(10) Pub. No.: US 2023/0245119 A1
(43) Pub. Date: Aug. 3, 2023

(54) SYSTEM AND METHOD FOR TIMING ADVISOR

(71) Applicant: Source Ltd., Valletta (MT)

(72) Inventors: Shmuel UR, Shorashim (IL); Ilya Dubinsky, Kefar Sava (IL)

(73) Assignee: Source Ltd., Valletta (MT)

(21) Appl. No.: 17/588,491

(22) Filed: Jan. 31, 2022

(51) Int. Cl. G06Q 20/40; G06F 17/18

(52) U.S. Cl. CPC G06Q 20/401; G06F 17/18

(57) ABSTRACT

A system and method for transaction timing including, assigning a newly seen transaction to a bin among a plurality of bins, each bin describing a plurality of past transactions. Thereafter, selecting a bin based on the transaction value of the newly seen transaction and a probability statistic of the corresponding bin. Transmitting transaction timing advice derived from characteristics of the selected bin to the first computer and displaying the transaction timing advice on the first computer.

### FIELD OF THE INVENTION

The present invention relates to determining the timing of transactions. In particular, embodiments relates to determining the timing of transactions using input data describing the transaction environment in order to determine timing advice for a transaction.

### BACKGROUND OF THE INVENTION

In many transaction technology systems, two related entities, for example, a sender and a receiver, e.g. a merchant and a customer, or any two remote entities, may conduct asynchronous, possibly repeating transactions, in which the entities send data or items amongst each entity (e.g. conduct a transaction). Transactions may be conducted once at a specific time, or on a scheduled basis (e.g. once every month). For example, a patient may have a prescription refilled once per month, delivered by mail to the patient. A customer, such as individual shopping from an online merchant (e.g. an online merchant such as Amazon.com) may purchase a product using computer systems sending information across a network such as the internet, where the product is delivered to the customer by a shipping service.

Typically, a transaction may involve multiple steps, and transaction technology may involve an exchange of data over computer networks. For example, when a customer purchases an item from an online merchant such as Amazon.com, purchases may first need to be cleared. Thereafter, the item may be shipped once payment has been successfully received. Therefore, a transaction may involve multiple steps that may be dependent upon each other (e.g. payment clears first then item may be shipped). However, the determination of when to conduct such transactions (e.g. charge a customer, deliver a product) may be important to ensure cost effectiveness and maximum profitability. For example, for an item delivery, a customer may not be home to receive the product. External situations, such as inclement weather, shipping service congestion, inadequate delivery staffing, may further exacerbate delivery delays. For payment transactions, when a merchant attempts to charge customers with an inability to pay, customers may be dissatisfied while the merchant may simultaneously receive no payment from the customer. In another example, in network transactions, a sender may send large amounts of data over the internet (e.g. peer-to-peer (P2P) sharing) to a receiver, and complications could arise such as network congestion, maintenance bottlenecks, or perhaps the receiver may be only partially available.

The choice of when to initiate a transaction (e.g. when to prompt, when to send, when to deliver, etc.) may greatly impact the utility or value of a delivery or transaction to a customer or a merchant. For example, the expected costs associated with the delivery or transaction may be lowered, a customer may be more satisfied with the delivery of a product (e.g. customer received product sooner). For example, if it was known a customer is not home or available to receive a package that he or she ordered, the package may be left on the premises, possibly open to potential thieves to loot the package (e.g. porch pirates), resulting in lost package claims, or be undeliverable, resulting in a waste of a delivery driver's time and effort.

### SUMMARY

Embodiments of the present invention may include a method and system for transaction timing advice. Embodiments of the invention may include: assigning, by a processor, a newly seen transaction to a bin among a plurality of bins, each bin describing a plurality of past transactions; selecting, by the processor, a bin based on the transaction value of the newly seen transaction and a probability statistic of the corresponding bin; transmitting, by the processor, to the first computer, transaction timing advice derived from characteristics of the selected bin; and displaying the transaction timing advice on the first computer.

Embodiments of the invention may include calculating a probability statistic, wherein the probability statistic is determined as the ratio of a number of successful transactions in a bin to a total number of total transactions in the bin, wherein the total number of transactions is a sum of the failed and successful transactions. The probability statistic using past transactional data to provide a probability statistic for future newly seen transactions.

Embodiments of the invention may include calculating a merchant value, the merchant value determined as an expected value of success minus an expected value of failure, wherein the expected value of success is the probability statistic multiplied by a transaction value and the expected value of failure is the probability of failure multiplied by the cost of a failed transaction. The merchant value may be a forward-looking value which factors utility and is used to adjust the probability statistic.

Embodiments of the invention may include calculating a probability statistic according to a deep-learning machine learning model.

Embodiments may provide a dedicated service that provides advice on the timing of a transaction based on gathered input data of the transaction environment. The timing advice may be provided for a single or any recurring periodic transaction.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a high-level block diagram of an exemplary computing device according to some embodiments of the present invention.

FIG. 2 depicts a block-diagram of a system for a timing advisor to embodiments of the present invention

FIG. 3 depicts an example flow diagram of a timing advisor algorithm according to embodiments of the present invention.

FIG. 4 depicts an example of two feature vectors, each feature vector representative of a transaction according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments. For the sake of clarity, discussion of same or similar features or elements cannot be repeated.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

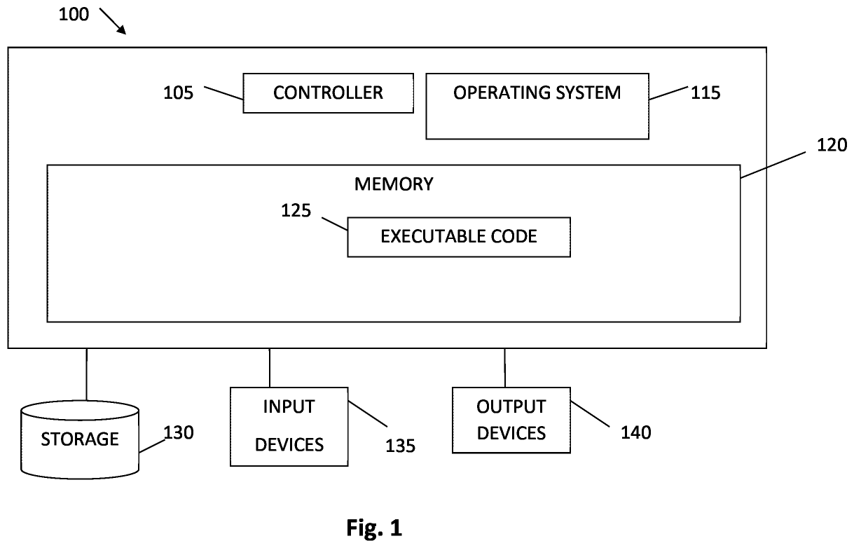

Reference is made to FIG. 1, showing a high-level block diagram of an exemplary computing device according to some embodiments of the present invention. Computing device 100 may include a controller 105 that may be, for example, a central processing unit processor (CPU), a graphics processing unit (GPU), a chip or any suitable computing or computational device, an operating system 115, a memory 120, executable code 125, storage or storage device 130, input devices 135 and output devices 140. Controller 105 may be configured to carry out methods described herein, and/or to execute or act as the various modules, units, etc., for example by executing code or software. More than one computing device 100 may be included. For example, by executing executable code 125 stored in memory 120, controller 105 may be configured to carry out a method for generating case-based data as described herein.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that when executed generates transaction timing advice as further described herein. A system according to embodiments of the invention may include a plurality of executable code segments similar to executable code 125 that may be loaded into memory 120 and cause controller 105 to carry out methods described herein. For example, units or modules described herein may be, or may include, controller 105 and executable code 125.

Storage device 130 may be any applicable storage system, e.g., a disk or a virtual disk used by a VM. Storage 130 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content or data may be stored in storage 130 and may be loaded from storage 130 into memory 120 where it may be processed by controller 105. In some embodiments, storage device 130 may be used for storing data related to transaction timing data. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by input devices 135 and output devices 140. For example, a wired or wireless network interface card (NIC), a printer, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

The storage medium may include, but is not limited to, any type of disk including, semiconductor devices such as read-only memories (ROMs) and/or random access memories (RAMS), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system according to some embodiments of the invention may additionally include other suitable hardware components and/or software components. In some embodiments, a system may include or may be, for example, a personal computer, a desktop computer, a laptop computer, a workstation, a server computer, a network device, or any other suitable computing device. For example, a system according to some embodiments of the invention as described herein may include one or more devices such as computing device 100.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

Prior art transaction timing is based on a simple set of principles. In prior art systems, transaction timing is dependent on a few generalities regarding the transaction environment. For example, the decision on when a transaction is initiated (e.g. when to send a delivery, send information or data, when to charge payment (e.g. send a payment request to the payee's bank or credit card company), or any other timing decision) may depend on a current time and preferences of either a sender (e.g. fulfilling the transaction) or receiver (e.g. accepting the transaction). For example, a buyer (e.g. receiver) may finance a vehicle and pay monthly installments to a merchant (e.g. sender) such as a financing company. However, the monthly installment will be due on a certain day every month, the date usually a selected by the merchant, in this case the financier. Regardless of the buyer's ability to pay, their preferences, or their situation or circumstance, the installment will be due every month on the same date. Technology carrying out such transactions may be improved in various embodiments of the present invention to provide more accurate timing, or better likelihood of success for transactions.

Embodiments of the invention may provide an automatic and efficient method for generating optimal transaction timing advice to a sender or requester that is involved in a transaction with a receiver. According to embodiments of the invention, the optimal timing advice may be provided by a dedicated entity, separate from the sender, responsible for determining optimal transaction timing advice. For example, the timing advisor may be a separate module queried by the sender or an embedded component of a sender's systems. In other embodiments, the entity may be embedded or created within a sender's systems. Embodiments of the invention may include the technology of sending transactions across computer networks, and transaction processing and timing in general, for example by collecting relevant data and applying data science and/or machine learning principles to more efficiently transmit transactions, or provide more accurate timing for transactions to be carried out.

A receiver as described herein, may be an entity linked to a sender by a transaction. For example, a receiver may be an individual, person, or client such as customer involved in a transaction with a merchant. For example, a customer may receive a delivered product (e.g. prescription, products, food, gifts, etc.) purchased from a sender such as a merchant (e.g. online retailer such as Amazon.com). A customer may have preferences or circumstances which may affect the transaction. For example, a customer may prefer to pay for a transaction after first securing enough funds, such as receiving their salary payment. In another example, a customer may purchase a high value item (e.g. such as a cell phone) from an online retail merchant and may want to be physically present to receive the item to avoid situations of theft or loss.

A sender, also referred to herein as a querier or requestor, may be, for example, a user or entity conducting transactions with a receiver. Senders may fulfill transactions with customers, and may query a timing advisor module for timing advice on fulfillment of transactions. For example a sender may be a merchant conducting a transaction with a customer (e.g. a receiver) such as a initiating a payment charge to the customer, and the sender may require timing advice on when to initiate the charge with the customer. A sender may also have preferences or circumstances which may affect transactions. For example, a sender such as an online retail delivery merchant may have a circumstance wherein inventory is not in stock. Therefore, merchants might have preferences to delay such transactions (e.g. deliveries) until items are restocked. In other examples, delivery drivers may only be available for delivery during certain batch periods (e.g. delivery batching), periods of time wherein workers are able to work and make deliveries. Therefore, a merchant may choose to only conduct transactions during valid batch periods.

When discussed herein, a transaction may include data representing a transaction, which may be transmitted over a network.

A query as described herein may be a request to a transaction timing advisor sent by a sender. The query may include input data about the transaction environment as described herein. Examples of some input data may include, preferences of the sender, preferences of the receiver, data about the receiver, data about the transaction, time of transaction, etc.

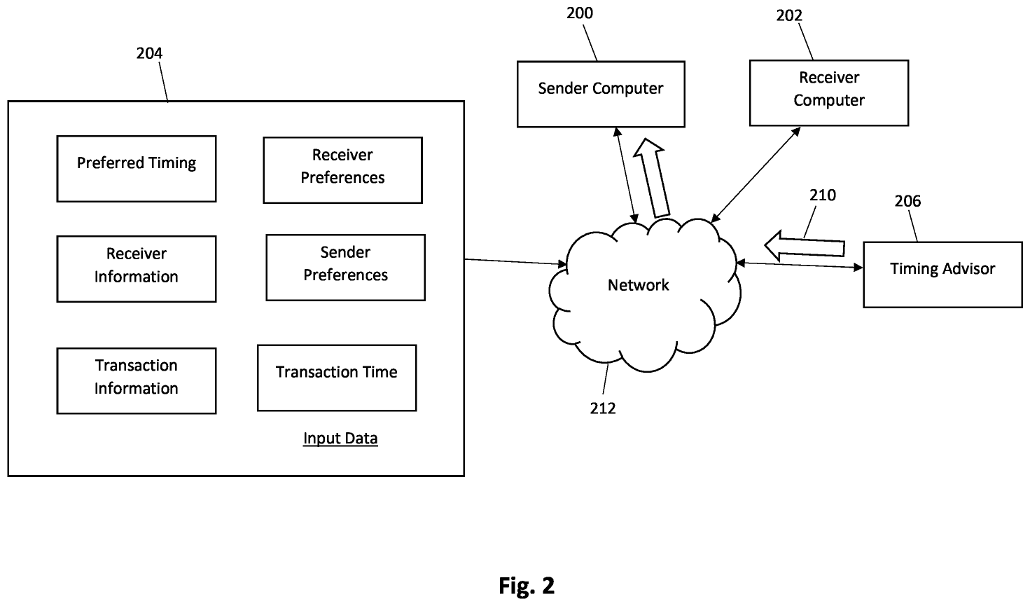

Reference is now made to FIG. 2, which is an illustration of a timing advice system according to embodiments of the present invention. The system may include a sender computer 200, receiver computer 202, input data 204, timing advisor 206, and timing advice 210. The various components of FIG. 2 may be in some embodiments separate or remote from each other, and connected by one or more networks 212, such as the internet.

FIG. 2 depicts a sender computer 200 configured to receive or collect various forms of input data 202. Sender computer 200 may be a computing device, as shown above in FIG. 1 configured to receive various forms of input data. Input data may include datasets of information about a transaction environment (e.g. transaction characteristics), retrieved or accumulated over time. A transaction characteristic as described herein refers to any information regarding a transaction and the participating parties of the transaction. For example, when a sender computer 200 such as a merchant, participates in a transaction with receiver computer 202, e.g. operated by a customer, the merchant may retrieve information on the customer and store such information to a database. In some embodiments, a computer may not be required for certain parties. For example, often a merchant may conduct business with a customer (e.g. over the phone, in-person) and a merchant may collect information about a customer such as the transaction information or the age of the customer. For example, a customer may use a cardmember's card and a merchant computer may identify a customer and their details.

Sender computer 200 may receive or collect input data 204 including, but not limited to:
Preferred Timing—This may be when a transaction or an element of a transaction may occur. For example, if a customer purchases a sofa from an online merchant for delivery, the preferred timing may be the dates in which the merchant has workers that can send the sofa. For example, the merchant may only have vehicles available for delivery on certain days, therefore, in this example days other than the available days are not considered. A preferred timing may therefore be a constraint on timing, such as the blocks of time wherein transactions may occur. Constraints may include timing restrictions due to resource allocation (e.g. delivery driver schedules), costs, time (deadlines), or any variable which may prevent a transaction from occurring.
Receiver Information—Information about the receiver. Typically, this is information a sender (e.g. such as a merchant) may have describing specific receivers (e.g. such as a customer) involved in transactions with the sender. For example, this may be information retrieved from receiver computer 202 by sender computer 200. For example, a merchant may know a customer's address, payment processor type (e.g. Visa or Mastercard), what floor a customer lives on, what day a customer receives their paycheck, age, gender, etc. Receiver information may include information a sender may not know. For example, receiver information may include statistical inferences of the receiver or gathered third-party information regarding the receiver. For example, a sender may not have information regarding the receiver's demographics, their average salary, their occupation, etc. However, these values may be statistically inferred or determined and may be provided as receiver information. For example, publicly available databases, such as census data as provided by the United States Census Bureau, may provide statistics for a receiver and the demographics, the population, or economy for a region the receiver is located within. If, for example, a customer lives in a particular region, and no information regarding the customer is known, external information, retrieved from third-party sources such as census data may provide adequate assumptions.
Transaction Information—Information about the transaction. For example, for an item delivery, information may be collected regarding the item's cost, its physical size, quantity, and its weight. Transaction information may include transactional data such as invoices, purchase orders, credit card payments including information describing how much the total payment was, how many payments, the location of the payment, the industry or type of product purchased. Typically transaction information includes payment history, and when or if a transaction was completed. Transaction information is not limited to financial transactions, but may be applied to any form of settlement between two or more parties.
Receiver Preferences—When a receiver would like to conduct a transaction or an element of the transaction. For example, a receiver may prefer to conduct transactions after being paid (e.g. after a paycheck deposit); if a receiver is not home every Monday a preference may be that the receiver would not like to receive any packages on Monday. In monetary transactions, this may be preferences such as when payment can start, or what specific day of the month a customer would like to be billed.
Sender Preferences—When a sender would like to conduct a transaction or an element of the transaction. For example, a merchant may perform payment batching and initiate all transactions at the end of the month. Therefore, such a merchant would like all transactions to be scheduled on the last day of the month. A merchant may want to schedule delivery for days where delivery traffic is least congested and the most deliveries can be made. A merchant may have different costs for transactions (e.g. value of transactions) at different times. Or, for example, perhaps a merchant may need money from a transaction before a certain date to ensure business goals are met and may therefore initiate payment collections well before the deadline. Typically, these preferences may be adjusted or set by the sender and may embody any form of preferences a sender may have. Preferences may be set for example to maximize a sender's profitability, lower costs, and any other metric or value a sender may change to meet or exceed business goals.
Transaction Time—The time a transaction or an element of a transaction was, is advised to be, or will be conducted. Typically, this refers to past transactions, of which have been logged and documented. For example, the exact date and time (e.g. in some embodiments, and typically in computers, represented as the time since Epoch) of a transaction element in a historical transaction. In terms of timing advice, typically, the time of a transaction is the current time, however, the transaction time may be delayed. It would be ideal to conduct a transaction at the current time, but transactions may need to be delayed given circumstances. Timing advice 210 may provide for example the amount of delay from the current time. Time is not limited to date/hours in a month, but may be any increment of time (e.g. minutes, monthly, bi-weekly, etc.). The transaction time may be a characteristic of past transactions and also may be advice or recommendations for transactions having a future recommended timing advice (including in cases of re-calculation of timing advice).

Input data 204 may be some form of data readable by computing device 100 (e.g. processed by processor 105). For example, input data may be in the form of a .csv file format, wherein the input data entries may be manually input by, for example, input device 135. Input data 204 may be collected or gathered from any external sources such as third-party databases and formatted accordingly. For example, input data 204 may include data collected from customer database services such as the customer databases of, e.g. the customer relationship management (CRM) of the Zendesk service or Freshsales service. Input data may include any form of data related to the sender, the receiver, the transaction environment, or any other data used to determine timing advice for a transaction.

Sender computer 200 may be operatively connected to timing advisor 206 and send input data 204 to timing advisor 206 to be processed by timing advisor 206. Timing advisor 206 may be a computing device such as in FIG. 1 and may determine timing advice for transactions, timing advice 210. Timing advice 210 may be sent to sender 200 through network 212 to be used by sender computer 200 to optimally time a transaction. Timing advisor 206 may be a separate entity from the sender 200 (e.g. merchants), for example, timing advisor 206 may be a network service hosted on a third-party server that may be queried upon request for timing advice. For example, merchants may query a timing advisor 206 (e.g. large payment processors such as Credorax or Visa may provide timing advice) over a network to determine an optimal time (e.g. timing advice 210) to process their transactions with customers, or advice, messages or alerts to provide customers. In other embodiments, sender 200 may be operatively connected to timing advisor 206. For example, timing advisor 206 may be a built-in service such as a software application executed on a merchant's systems, actively collecting input data 204 and calculating timing advice 210. In FIG. 2, a preferred embodiment is depicted where the sender 200 and timing advisor 206 are separate entities, however, the timing advisor 206 and sender 200 need not be separate entities and are not limited as such. Sender 200 may display transaction advice such as timing advice 210 to a user operating sender 200.

Timing advisor 206 may be on standby until certain conditions are met or triggered. The timing advisor 206 may be used to provide repeat or updated timing advice when the timing advice 210 sent to sender 200 did not result in a successful transaction or outcome. Timing advisor 206 be triggered by the sender 200 for new or updated timing advice at a sender's request. For example, timing advisor 206 may be queried by a merchant, usually due to triggers such as non-payment or a change in the transaction environment. For example, after timing advice 210 has been calculated by the timing advisor 206, if the timing advice 210 sent to the sender computer 200 resulted in a failed transaction (e.g. payment wasn't collected by a merchant, delivery unsuccessful, etc.), the sender may query the timing advisor 206 again for a recalculated timing advice. Changes to the transaction environment, such as a change in a customer's information (e.g. receiver information), preferences, or any input data changes, may also trigger timing advisor 206 to produce recalculated timing advice. If the recalculated timing advice 210 is different than the original timing advice determined by timing advisor 206, the merchant may be informed of the new timing advice calculated by the timing advisor 206. In FIG. 2, a preferred embodiment is depicted where timing advisor 206 is a single entity, however, timing advisor 206 may be one entity or multiple linked entities according to embodiments of the present invention.

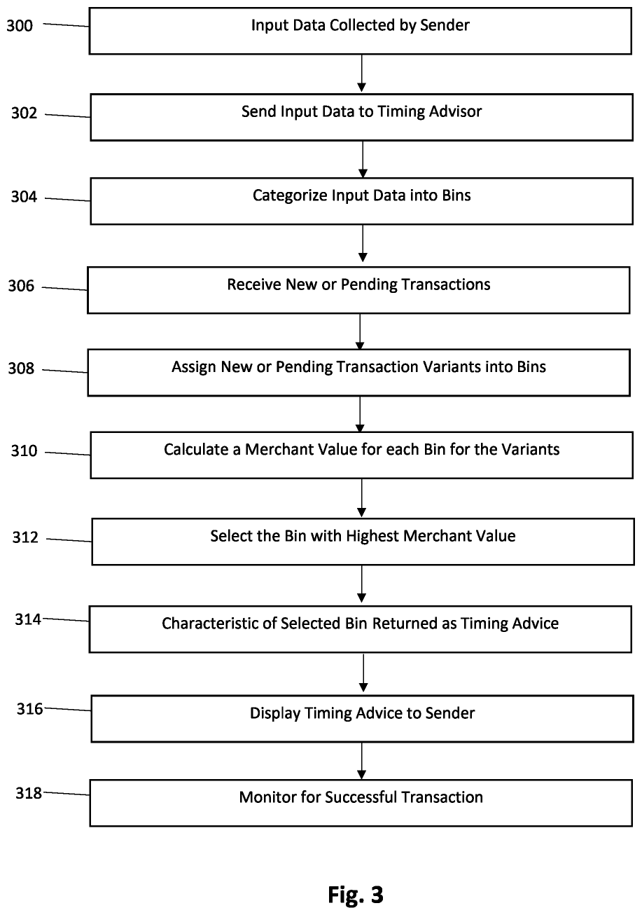

FIG. 3 is a flow chart for a method of calculating timing advice according to embodiments of the present invention. Operations as described in FIG. 3 may be executed by elements of FIG. 2 such as by timing advisor 206, but other systems may be used to carry out the methods described herein according to embodiments of the present invention. At step 300, input data (e.g. input data 204 of FIG. 2) may be collected (e.g. manually input via input device 135 or may be collected from datasets as described in conjunction with FIG. 2). Datasets may include past transactional data, with the history of transactions completed (or uncompleted) by a particular sender (e.g. merchant). For example, a magazine publisher may have a dataset of collected transactions with all its sales, subscribers, payment, and delivery data. Input data, collected by a merchant (e.g. sender computer 200) may include, by not limited to, information on timing preferences, data about a receiver (e.g. customer) that the merchant is involved in a transaction with, transaction information, customer preferences, merchant preferences, transaction time, or any other data related to the transaction environment. Example input data may include multiple transactions occurring in the past across multiple different customers, including whether payment was received, delivery was successful, etc.

Each of a collection of past transactions may be assigned a bin, each bin describing a number of past transactions or defined by transaction characteristics (e.g. age<X; location in area Y; A<transaction value<B, merchant ID, merchant type, date, etc.), each bin associated with a probability of success (e.g. likelihood that payment was made). A database may be developed including transactions and payment results for each transaction, and this database may for example be divided into bins or clusters (e.g. to train a model which is made of bins), each bin or cluster including transactions with related characteristics, and/or input to an ML algorithm for training. Transaction information input may include a status of whether the transaction was successful (e.g. customer was at home to receive a product, whether a payment was successful, etc.). Dividing past transaction data into bins may be considered training a model based on past transaction data, where the model is a plurality of bins. In other embodiments, methods for determining the probability of success for a new transaction or a variant of a new transaction may be used other than bins, e.g. using machine learning models.

At step 302, input data may be sent to a timing advisor (e.g. timing advisor 204 of FIG. 2). Input data may be transmitted through a network to be processed by timing advisor module 204 located at a third-party server. In other embodiments, input data may be processed on an embedded timing advisor module (e.g. a software program on a sender's systems, or a hardware implementation such as a field programmable gate array (FPGA)).

Input data may be processed in batches. For example, a merchant may specify collecting transactions (e.g. each with its own timing and constraints) in batches (e.g. such as a processor/acquiring bank). A batch may specify the number of transactions or may have constraints such as a range of values. For example, a batch may have a maximum number of 100 transactions allowed per day or may be constrained to be within a certain dollar amount (e.g. more than $10,000 and less than $20,000). Batch processes are orchestrated through third-party systems more effectively. For example, batches may allow third-party systems to process input data “off-peak” and allow orchestration of input data. For example, if third-party timing advisor services are overloaded, transaction information may be fed to the service in a throttled manner to avoid overloading the service.

Therefore, the selection of which batch to process and/or when may affect the efficiency of transactions. As such, transactions may be batched accordingly to increase both the probability of success of a transaction as well as to reduce costs. Batching or grouping may be performed by a processor and methods described herein. Generally, transactions may be more costly to process during peak hours as computing resources are heavily trafficked during business hours (e.g. typically from 9:00-17:00). Therefore incoming transactions may be batched to account for such conditions. For example, for 1,000 transactions, assume there are 4 batches spanning 24 hours each occupying a span of 6 hours (e.g. ¼ of a 24 hour day). Batches may be spanned accordingly, starting from midnight: Batch 1 (0:00-5:59), Batch 2 (6:00-11:59), Batch 3 (12:00-17:59), Batch 4 (18:00-23:59). It may be highly advantageous to process transactions with low priority (e.g. transactions may be marked by a level of priority indicating urgency, such as high or low priority) during off-peak hours. Transactions may be batched according to costs, described herein, and be processed during off-peak hours. Therefore, for the 1,000 transactions, high priority and high cost transactions may be placed in Batch 2 and Batch 3 (e.g. peak hours) whereas low priority and low cost transactions may be placed in Batch 1 and Batch 4 (e.g. off-peak hours) to be processed. Transactions may also be batched to increase the probability of success of transactions. For example, if a particular batch processing transactions is bottlenecked and overburdened, transactions may be diverted to other batches (e.g. other institutions in need of traffic, orchestrated through internal systems to other batches, queued at a different microservice, etc.)

A batch in the context of delivery and logistics, may be a dispatch of a delivery only after a consignment of goods meets certain sizes or are destined for a common destination. For example, a delivery truck may ensure the consignment of goods is over a certain weight amount (e.g. load weight over 4,000 lb for a 8,000 lb Gross Vehicle Weight Rating (GVWR) vehicle) or that the quantity of packages exceed a certain number (e.g. more than 500 packages). Additionally, batching deliveries may be based on location, allowing delivery of packages at or near the same area and/or within a predefined radius (e.g. packages do not exceed a 3 mile radius of destinations).

At step 304, the timing advisor may categorize the input data into bins; e.g. each bin describing or categorizing a number of past transactions. Input data, which may include past transaction information (e.g. historical data on previous transactions) may be categorized into bins. Assume that a set of past transactions for the month of November is received as part of input data, the transaction data including information on the location of the transaction, the day it was performed, the type of transaction, and the demographics of the customer. This information may be received in past transactions from a merchant such as e.g. Amazon, Visa, or any payment clearing house which tracks or collects information on their customers. Assume that for each past transaction, a transaction falls into one combination including one each of the following characteristics which may vary across transactions:
3 cities (London, Manchester, Liverpool)
30 different days (each day in the month of November)
2 different transaction types (large transactions>, $6000, small transactions<$6000)
4 different types of customers (male older than 18 years of age, female older than 18 years of age, male child under 18 years of age, female child under 18 years of age)

Given the above assumptions, it can be seen that there are 3*30*2*4=720 different combinations, each combination herein may be or may be assigned a group or category, referred to as a “bin”. If provided a large dataset of transactions data (e.g. more than 100,000), a probability (e.g. of success, of successful payment, etc.) may be calculated for each bin. This probability may be based on an average or other statistical measure for a characteristic across all transactions in a bin, e.g. an average of the binary “paid”/“not-paid”. This average characteristic may be returned as an output for this characteristic for the bin. Different bins may thus have different outputs for a certain characteristic.

Each respective bin represents a group or category for a transaction and each bin may have a probability attached to the bin. For example, assume that out of a large dataset of transactions data, exactly 10,000 transactions fall within a particular bin as specified in the following: London, 8^{th} of November, small transactions, male older than 18 years of age. Also assume that out of the 10,000 transactions that fall within this specified bin (e.g. each transaction in the bin was performed on the 8^{th} of November in London, by an adult male spending less than $6,000), exactly 3,333 transactions have been defaulted by a customer (e.g. customer didn't pay, cancelled, transaction failed). Therefore, for this specified bin, 33.3% (3,333 defaulted transactions/10,000 total transactions) of transactions have been defaulted by a customer. Inversely, a complement of 66.6% of past transactions were successful, therefore the probability of success for this particular bin and transactions which are categorized (e.g. classified) to this bin is therefore 66.6% (1−0.333). Therefore, this probability may be used for new or pending transactions which are categorized into this particular bin and therefore may provide a probability of success for transactions which categorize into this particular bin. From examining past transaction data, a probability may be calculated for each bin by determining a ratio of the number of successful transactions in a particular bin to the total number of transactions for that particular bin. The bins may be updated based on completed transactions, resulting in more precise probability rates for bins over time. For example, over time, transactions will accumulate, each with a resultant success or failure, the completed transactions may be fed back and categorized into a bin, resulting in a larger dataset for increased accuracy of the probability statistic.

In certain embodiments, the calculation of the probability statistic may further be extended to a deep-learning machine learning model. Machine learning algorithms such as support vector machine (SVM), neural networks (NN), convolutional NNs (CNNs), decision trees, may allow the incorporation of details not specified by the groups or bins described herein. Through machine learning, information not known by a merchant about their customers (e.g. received as part of input data) may be included to output a probability statistic. For example, information such as input data describing a customer (e.g. transaction characteristics), for example a customer's demographics (e.g. customer's gender, age, occupation, income, neighborhood where they live) may be synthesized and included in a probability statistic. A model may be trained given transaction characteristics of concluded transactions (e.g. past transaction data) indicating a past transaction success and various forms of input data describing a customer. The output of this model may be a probability statistic. In some embodiments, such machine learning may be used to create bins, divide data into bins, or in place of dividing data into bins. For example, transactions may be used to train a classifier ML model, the trained classifier when taking new input (e.g. a new transaction), may output multiple classifications on the probability statistic (e.g. likelihood of success), or “paid/not paid”, similar to the bins providing this output. The classifications may result from multiple versions (e.g. variations) of the new transaction, each may have a plurality of similar transaction characteristics to the new transaction but with a different timing characteristic (e.g. such as the date), similar to the multiple variations each associated with a bin. Multiple versions (e.g. the same transaction with data varying among the versions being future transaction timing) of a “new” transaction may be input to the ML model, and the version (e.g. bin) classified with a highest transaction success value (e.g. merchant value) may be returned. The transaction success value may be determined from the classified probability statistic as described herein a merchant value. The timing characteristics associated with the classified highest transaction success value may be used for a recommended timing advice.

As an example, a merchant may have a transaction corresponding to the exampled bin above (London, 8th of November, small transactions, male older than 18 years). However, with the machine learning model, information not encompassed by the bin may be included. For example, it may be known that the customer is a member of one or more groups, e.g. employed as a teacher (e.g. employment group) and lives in a low income neighborhood (e.g. geography group). Customers from a low income neighborhood may be known to have higher levels of transaction default if charged during certain periods due to payment cycles of certain employers. As another example, a customer's billing zip code may provide valuable information on, or be a proxy for, a customer's income level and their average credit score. Even generalizations such as an occupation may be determined. For example, some zip codes may have a large number of people employed in a finance occupation. Occupations such as finance may be strong indicators of low levels of default. Therefore, such zip codes or occupations may disproportionately experience lower levels of default, and thus have higher probability statistics as compared to others.

In another example, a certain type of customer may cancel transactions with a high probability (e.g. buyer's remorse), such as a customer that habitually returns bought products. Input data regarding a payment type of the customer, for example, the use of a credit card, check, or cash may influence default rates. For example, merchants often experience credit card fraud, wherein a customer may report a credit card charge as fraudulent even though the product or service was rendered legitimately. A customer's bank type may also influence the probability statistic. For example, customers of bank A may experience higher delinquency than customers of bank B (for example, bank B may vet its customers with more stringency). A machine learning model may aggregate input data to be trained, to cluster input data into bins in order to determine a probability statistic for each bin.

In other embodiments, a selection of a bin may depend on geography, the merchant, an amount, knowledge re the buyer, and product, a date and other factors.

In other embodiments, a machine learning model may cluster input data such as geography, information about a merchant, an amount, knowledge regarding a buyer, data about product, a date and other factors into bins. For example, people from different states may have calculated for them a different bin and therefore may reflect a different probability statistic. The probability statistic may further be refined to be based on the product purchased. For example, some products that people buy are more likely to result in successful transactions than others. For example, a small value item such as a pen may result in a much lower default than a high value product such as a laptop. The probability statistic may further depend on the date, as in some dates, buyers may have more money in their accounts such that transactions are more likely to be successful. A few examples of input data affecting the probability statistic are exampled herein, however, many other factors may affect a bin and the corresponding probability statistic.

The machine learning model may be trained, for example, by input data collected from a plurality of sources such as previous transactions and external third-party customer data (e.g. data describing demographics, census data, etc.). Public databases (e.g. https://www.incomebyzipcode.com/) may be used to obtain data or outside information, e.g. large scale events, and correlations may be identified between those events and transaction data. External events, such as news information may impact transactions. For example, the United States government may provide a stimulus check for the 8th of the month. Machine learning allows the identification of a known public event with a correlating change of transaction behavior for a group, known as “clustering”. Consumers who use payment processors such as Visa as compared to American Express may face different circumstances and may therefore be placed in different clusters. Input data may data obtained from statistical inferences of an area. For example, even if no data is known about a customer and only the general geographic area of the customer is known. Based on the statistical data about a general geographic area, for example, in Chicago, it may be observed that the best time for a $15 transaction is at 7 am on the 8th of every month in the Chicago area, and at 8 pm on the 5th of every month in the New York City area. However, for a high-value transaction, for example $2,000, the transaction times could be drastically different. Each of these observed transactions may be categorized into a cluster or group such as a bin using machine learning.

Embodiments of the invention may first classify transactions, typically using a machine learning algorithm such as a k-means function, decision tree, or NN. For example, a classifier may be trained using existing input data to classify transactions into groups or classes; alternately such a classifier may be used to classify transactions without the result of classification into groups or bins. Each class may be associated with a particular bin, calculated by the transactions within the class. New transactions received may be placed in the bins using the machine learning algorithm (e.g. it may have its characteristics converted to features, input to the machine learning model, which then assigns it to a group or class). The groups or classes of transactions may therefore be calculated for a probability statistic, similar to step 304.

Embodiments of the invention may construct a feature vector including information extracted from the input data to create a training data feed into a machine learning model. Each row of training data may be a vector representing a transaction and may specify information regarding a transaction. The information regarding each transaction may be features in the feature vector. Input data, both quantitative and qualitative, may therefore be quantized and normalized. The input data may then be included as part of a feature vector, represented as a row vector wherein each entry of the row vector corresponds to a feature of a transaction. For example, for a transaction, the average credit score of a customer's billing zip code may be included as a feature of the feature vector. Additionally, a customer's income may be given a quantized value (e.g. 1 to 7, for the 7 tax brackets in the United States) based on which tax bracket the customer belongs to. Existing feature vectors may be combined to create a new feature by applying a set of constructive operators (e.g. multiply, divide, add, etc.) in a process referred to as feature construction. Each feature of the feature vector may also be weighed, the weights placed in a corresponding column vector to perform a dot product.

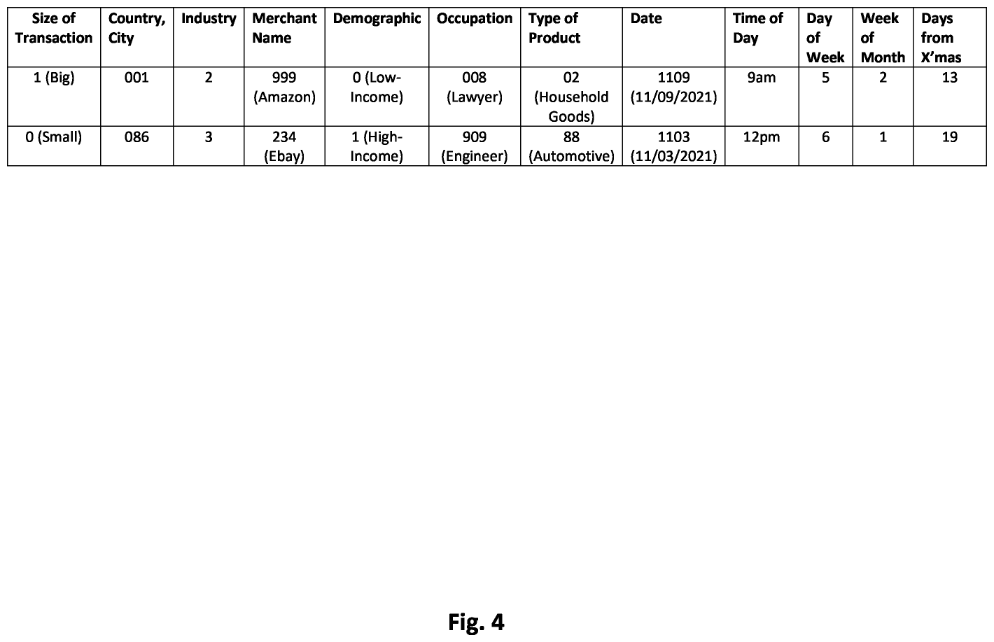

Shown in FIG. 4 is an example of two feature vectors, each feature vector representative of a transaction according to embodiments of the present invention. As shown in FIG. 4, each of the qualitative values (e.g. Big, Amazon, Low-Income, Lawyer, etc.) may be quantized to integer values. For example, big or small transaction size may be represented by a binary 0 or 1, respectively, a country may be represented by a country code (e.g., 001 for USA, 086 for China). Qualitative features may be represented by any values, as long as the user creating such arbitrary values comprehends such values.

The probability statistic may thus be a function of the new and pending transaction itself, the time of the transaction, past historical transactions and information known about the customer (e.g. receiver). This may be a function that returns a value between 0 and 1. For example, Probability (pending transaction, past transactions, transaction time, receiver information)={0,1}.

At step 306, a future, newly seen, or pending transaction may be received and sent to timing advisor 206 to be calculated for timing advice. For example, a newly seen or pending transaction such as a customer purchasing a sofa from a furniture merchant for which payment has yet to be charged by the merchant to the customer. The furniture merchant may send the pending transaction to the timing advisor to be calculated for timing advice on when to charge the customer, when to deliver to the customer, or other information. In a delivery scenario, a delivery merchant may receive an order to be delivered to a customer. The delivery merchant may send the pending transaction to the timing advisor to be calculated for timing advice on when to deliver the order to the customer. The new or pending transaction may include transaction data or characteristics, such as information on the location of the transaction, the day it was performed, the type of transaction, and the demographics of the customer.

At step 308, the newly seen transaction may be assigned to one or more bins from among the bins. For example, one or more bins may be determined or selected corresponding to the newly seen transaction from among the bins. For example, the new or pending transaction may be categorized into bins depending on the transaction data of the new or pending transaction. This process may be similar to categorizing the input data into bins as in step 304. For example, continuing the example above, a new or pending transaction may have the following example transaction data: the transaction was completed from London on the 8^{th} of November, it was a small transaction, and the customer was a male older than 18 years of age. Therefore, the new or pending transaction may be categorized into the same or similar bin as described at step 304. Once categorized into a particular bin, the new or pending transaction may be assigned a probability statistic indicating the probability of the new or pending transaction being successful. The new or pending transaction therefore acquires the probability of the bin (e.g. determined from past transactions) in which the new or pending transaction is categorized.

Each of a number of variations of a new transaction may be assigned to multiple bins, where each variation has a different value than do other variations for a certain transaction characteristic, but the same values as other variations for other transaction characteristics. For example, in order to determine the best characteristic for a variable characteristic, such as payment or delivery timing, multiple variations of the same new incoming transaction may be created, each with a different option for a certain characteristic, such as a first variation of deliver magazine A, to person having characteristics B, at time or date C1; a second variation of deliver magazine A, to person having characteristics B, at time or date C2, etc. In this example the delivery date or time is varied and all other characteristics remain fixed across the variations created. Each of these variations may fit in a different bin, based on the definitions of the bins. Thus a new or pending transaction may be categorized into multiple bins, one for each of the variations. For example, the new or pending transaction may be analyzed for a probability statistic for a week following its receipt or generation, such that a variation on the transaction is created corresponding to each of the days after the date of the new or pending transaction and placed in a bin corresponding to the future date. A new or pending transaction may be categorized into multiple bins, with other information constant, but may have the date modified starting from the 9^{th} to 15^{th} of November, such that multiple bins each with a different probability statistics may be determined.

At step 310, for each variant of a newly seen or pending transactions, a merchant value may be calculated for each bin associated with a variant the new or pending transaction was categorized. A pending transaction may be checked for a few possible dates (e.g. variants, belonging to different bins) and thereafter an embodiment may select a highest merchant value bin, described here. Input data (e.g. received at step 302) may include merchant and customer preferences and/or constraints and may have assign a value of a transaction at a specific time (in the case that transaction time is one characteristic varying across bins, each bin for example having a range of time). Similar to the probability statistic, merchant values may be assigned for each bin. Thus, in some embodiments, each bin may have a merchant value which is associated with all transactions in that bin.

The merchant value may take into account one or more aspects. For example, a successful transaction for a merchant may be more valuable during certain time periods. For example, a merchant may prefer transactions to be processed before an inventory restock, ensuring enough funds for the restock purchase. Information such as a customer's perceived quality of service or a customer's satisfaction from service may be included as part of the merchant value. Business goals, such as customer satisfaction, ensuring repeat business, and growth (e.g. utility of a transaction to a customer) may be included in a merchant value. For example, generally, a customer prefers to receive package deliveries as soon as possible, the earlier the customer receives the delivery, the more utility it may provide to the customer. Typically, a customer may be more satisfied if the package was delivered earlier (e.g. provides more utility to the customer) such that the utility to the customer may be determined to be higher on particular days as opposed to others. This may be extended to days, weeks, month, etc., or any suitable period of time. Additionally, a customer's satisfaction with the transaction itself may be included. For example, utility to a customer may be forecasted such that it may provide the best transaction experience. The merchant value may reflect such sentiments.

The merchant value may reflect the likelihood a customer may be a repeat customer (e.g. high satisfaction). For example, if a customer receives a package earlier than expected, he/she may be more likely to re-order from the same merchant. Therefore, a merchant value may be forward-looking and factor utility, and therefore may be used to adjust the probability statistic. Therefore, for each new or pending transaction, a merchant value may be calculated. For example, assume there is a cost for a failed transaction, e.g. $5. This cost may be determined by the sender, for example, a merchant may evaluate the cost of a customer denying a delivery of a large item and the costs to the business for a failed delivery (e.g. dissatisfied customer, no repeat business). Perhaps a customer may be more likely to deny certain transactions (e.g. a product which is rated badly). Therefore, certain pending transactions may not be reasonable to attempt if the expected value of the pending transaction does not provide enough merchant value to the merchant to overcome the costs for a failed transaction. For example, assume that for a pending transaction, there is a 80% probability statistic (e.g. calculated according to step 304). Therefore, multiplying the pending transaction value (e.g. dollar amount of the pending transaction) by the probability statistic results in the value to the merchant if the transaction is successful. However, there exists a 20% probability of default (1−0.8), which may be considered a probability of failure. With failure, the costs of the failed transaction may be included.

In one embodiment, to calculate a merchant value for a certain transaction variant which has been assigned to a certain bin, the expected value of failure may be subtracted from the expected value of success, for that particular transaction, taking into account the probability of success from the bin to which a variant has been assigned. This may be done for a certain transaction (e.g. keeping transaction amount constant) varying the probability or likelihood of success (“probability statistic” in Formula 1, which is typically between 0 and 1) inherited by each variant. Thus for each variant, a merchant value may be calculated. A cost of failed transaction may be for example assigned to a bin and thus to a variant, or calculated in other manners. For example, the cost of losing the customer forever may be translated to a number, the cost of failed transaction. The cost of a failed transaction may include is the direct cost (e.g. shipping, not doing the business, financial cost) and/or the indirect cost (e.g. satisfaction, etc.). Each bin may include a value of the probability of failure. The cost of failure for a certain type of transaction may be similar between bins having different timing information. Each bin describing the same type of transaction with different timing may have a different cost, for example if the cost of return is different in different times. A bin value for each variation or for the new transaction, may be calculated, e.g. based on the probability of success for the bin and the value of the transaction: the bin value may be calculated based on Formula 1, based on the pending transaction value*probability statistic, and/or other factors.

The expected value of success and the expected value of failure are shown below in example Formula 1:

Expected Value of Success=pending transaction value*probability statistic

Expected Value of Failure=cost of failed transaction*(1−probability statistic)

Merchant Value=Expected Value of Success−Expected Value of Failure Formula 1

For each found bin of a pending transaction, the pending transaction value (e.g. the dollar amount of a transaction) may be multiplied by the probability statistic of the found bin for each variant. This may be calculated to be the expected value of success of the transaction. Thereafter, the costs to the merchant (e.g. such as utility to the merchant, utility to the customer, external forces determined by the VMM) may be multiplied by the complement of the probability statistic (e.g. 1−probability statistic) to determine an expected value of failure. Therefore, the merchant value is calculated as the difference between the expected value of success minus the expected value of failure. Multiple new or pending transactions may fall within a single bin and there may be multiple different merchant values for each bin. For example, a $3, a $5, and a $9 pending transaction may each fall within a single bin wherein the “costs of transaction is less than $10”.

Therefore, for the merchant to break even (e.g. Merchant Value=0), in this example the expected value of success must equal to expected value of failure. For a $5 cost of a failed transaction with an 80% probability of payment, according to Formula 1, the transaction payment amount must be greater than or equal to $1.25. A merchant would determine not to pursue a transaction if the merchant value were negative. A merchant value may be calculated for each pending transaction and only those transactions with a positive merchant value may be attempted. For the days where the transaction is restricted due to constraints in timing, the cost of a failed transaction may be set to infinity (e.g. or a very large number) such that these transactions are not attempted. For example, a merchant may have a timing preferences or constraints wherein transactions are not to be conducted on a Tuesday as the merchant may be short-staffed on Tuesdays. Therefore, a merchant may include in its timing preferences Tuesday as a high cost transaction. If it is necessary to avoid transactions on Tuesdays completely, the cost may be set to infinity, such that the merchant value is negative.

Additionally, the merchant value may include a value multiplier merchant (VMM), a VMM may be used to multiply the merchant value to quantify extraneous variables. For example, for large merchants, inflation may need to be accounted for in transactions. Perhaps a delivery during a holiday may increase overhead costs (e.g. overtime pay during holidays), therefore these transactions may be more costly, and thus be of lower value to a merchant. The VMM may capture these extraneous variables. An example of a VMM for the span of a month (˜30 days) to account for inflation is shown below:

TABLE 1

| Day of Month | Multiplier |
|---|---|
| 1-7 | 1.0 |
| 8-14 | .99 |
| 15-21 | .98 |
| 22-last | .975 |

Table 1 shows that the value of a transaction may be more in the beginning of the month as compared to the end (e.g. last) of the month, as over time, money may depreciate due to inflation. Therefore, some transaction times for a merchant are better than others and may have a VMM attached to the merchant value. A VMM does not have to be monotonically decreasing as exampled above, but can be any value which represents the extraneous variables of a transaction to a merchant. A VMM value may be positive in some situations. For example, a transaction may be worth more to a merchant on certain dates such as for a warehousing business, transactions may need to be processed before the purchase of a large inventory restock. Therefore, the VMM may be higher for the urgent dates the transactions should clear.

At step 312, a bin may be selected based on the merchant value of the variants of the newly seen transaction. For example, for a new or pending transaction (or for the multiple variations of that transaction created), the bin (e.g. the bin among the various bins the variations of the transaction has been placed in) with the highest bin value or merchant value may be determined, and the varied characteristic, e.g. payment or delivery timing, associated with that bin, may be returned as advice. Each bin which the new or pending transaction is categorized may have an associated merchant value.

At step 314, a characteristic of the selected bin (e.g. timing advice) may be returned. Attached to the selected bin with the highest merchant value may typically be characteristics of the bin (e.g. the variant), such as a date and time, e.g. 8^{th} of November at 3:00 pm. In other embodiments, the date and time may be more granular, such as seconds, the increments of time are therefore not limited in any way. The bin corresponding to the highest bin value or merchant value may be selected, and the date and time for the selected bin may be selected or determined as the timing advice and may be transmitted to the sender.

In some embodiments, the timing advice represents the optimal time when a customer should be billed, or when delivery should take place, etc. This timing advice may be the transaction time which provides the sender (e.g. merchant) the most value, least cost, and highest satisfaction to the receiver (e.g. customer). The sender may use the received timing advice to execute a transaction with the receiver accordingly. For example, the calculated timing advice may include a specific date that a merchant should charge their customers for purchases. In other embodiments, timing advice may be flexible. For example, instead of providing timing advice to the merchant of a certain time or date, timing advice may suggest a range of time, known as a “contract”. For example, instead of timing advice which informs the merchant to charge a customer on the 10^{th} of the month, timing advice may inform the merchant to charge a customer on or after the 10^{th} of the month, and provide a contract that is after the 10^{th}. If, for example, a merchant expects to charge a customer for the 25^{th} of the month, instead of charging on the 25^{th} of the month, a contract may be provided to encompass such dates. A contract may indicate a charge on or after the 10^{th} of the month, encompassing the 25^{th} of the month.

At step 316, the timing advice may be displayed on for example the sender computer to a user of the sender computer. For example, a sender computer may display on a monitor to a user (e.g. output device 140), the exact date and time of the transaction timing advice for which the pending transaction should be attempted to the receiver. Information about the pending transaction and the amount of the transaction may also be displayed. In other embodiments, for example, such as transactions for package delivery, a description of the package and the timing advice of delivery (e.g. advised delivery time) may be displayed to the user.

At step 318, the timing advice may be monitored for a successful transaction. In some embodiments, the transaction environment may change over time or the transaction itself failed. For example, assume the timing advisor provided timing advice for a merchant involved in product delivery (e.g. Amazon for example). The timing advice may have been determined by the example method in FIG. 3, but regardless, the delivery failed on said date. Perhaps there may have been an unexpected and unforeseen traffic congestion that delayed a product delivery and caused its failure. If input data regarding a receiver changes, for example the predictions for a customer's demographics (e.g. perhaps the customer moved) changes, then the merchant value may need to be recalculated. Therefore, in some embodiments, the timing advice may need to be recalculated for the sender and a new timing advice sent back to the sender.

Assume that for a delivery, the delivery failed on the calculated timing advice determined by the timing advisor 206. The merchant (e.g. sender 200) may trigger the timing advisor 206 with the failed delivery information which in turn may re-query timing advisor 206. Timing advisor 206 then proceeds to repeat steps 300-316 for a recalculated timing advice, which will be sent back to sender 200. Particularly, at step 302, the input data may include the failed delivery information or new input data, which may be used in recalculating the probability statistic in step 304.

In machine learning, the recalculation may be triggered when the class the transaction belongs to started to behave not as expected. When a pending transaction is received, the transaction is classified into a bin (e.g. as described in step 304 of FIG. 3). Each bin may contain a probability statistic. However, if the new transactions result in higher transaction failure rates than the predicted probability statistic, then the other new or pending transactions classified within this bin may be recalculated for a new probability statistic. For example, some transactions may be advised on the 8^{th} of the month because the class belonged to a bin consistent mainly of New York City teachers who get paid on the 7^{th} of the month. However, now there is more default than usual, it is unknown why, but it is the case. Therefore the bin is not behaving as expected and may recalculate all pending and new payments such that a new timing advice on the 11^{th} of the month may be determined.

In machine learning, often there may be a lack of input data for the machine learning classifier model to classify input data into bins. The use of a contextual-bandit algorithm may be implemented to test out different input data (e.g. contexts) and automatically learn which one has the most rewarding outcome (e.g. probability statistic) for a given situation or “bandit”. In contextual-bandit algorithms, which is an extension of a multi-arm bandit approach, multiple “bandits” (e.g. bins) may each have a reward associated with it (e.g. probability statistic) given a certain context (e.g. input data). In the multi-arm bandit approach, the context affects how a reward is associated with each bandit, so as contexts change, the contextual-bandit model may learn to adapt its bandit choice. For example, assume that for a set of bins ranging from the 15^{th} to 22^{nd} of the month, the bins are empty, as no historical transactions were encountered with these dates. A few genuine transactions may be attempted with a predetermined reward value (e.g. probability statistic). Timing advice may be calculated for these unknown dates and may automatically be learned for the most rewarding outcome by adjusting the input data. Thereafter, transactions may be completed and statistics may be collected to further refine the probability statistic.

In some embodiments of the invention, the pending transactions may be collected and processed in batches for the timing advice. Processing timing advice during off peak time enables systems to work more efficiently, thereby reducing the costs to process time. For example, a merchant may place constraints on the number of transactions (e.g. maximum 100 transactions processed for timing advice a day) or a dollar amount of transactions (less than $X and more than $Y a day).

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

1. A computer-implemented method for transaction timing advice comprising:
processing, by a processor, input data including transaction information;
classifying, by a neural network, one or more transactions into classes using the data;
clustering, by a first machine learning model, the model fed with training data created using a feature vector, the data into one or more bins, the bins describing a number of past transactions, wherein a particular bin is associated with each class;
assigning, by the processor, a newly seen transaction to one or more of the bins, wherein assigning a newly seen transaction includes using a variation of the newly seen transaction, wherein each variation has a different value than other variations for a transaction characteristic, but the same values as other variations for other transaction characteristics;
for each of the bins, calculating, by a second machine learning model, a probability statistic of transaction success, the machine learning model incorporating details not specified by the bins;
selecting, by the processor, one or more of the bins based on a transaction value of the newly seen transaction and the probability statistic of the corresponding bin;
transmitting, by the processor, to a computer separate from the processor, transaction timing advice, the timing advice including a characteristic of one or more of the selected bins and representing an optimal time for the processing of the newly seen transaction;
displaying the transaction timing advice on the computer separate from the processor;
producing, by the processor, a recalculated timing advice, the producing triggered by one or more changes to the input data; and
if the recalculated timing advice is different than the transaction timing advice, informing, by the processor, the computer separate from the processor;
wherein a plurality of pending transactions are collected and processed in batches for the timing advice.

2. The computer-implemented method of claim 1, wherein the probability statistic is calculated as the ratio of a number of successful past transactions in a bin to a total number of transactions in the bin, wherein the total number of transactions is a sum of failed and successful transactions.

3. The computer-implemented method of claim 1, wherein the selection of the bin is further based on an expected value of failure of the transaction, the expected value of failure calculated as a cost of failure multiplied by a probability of failure.

4. (canceled)

5. The computer-implemented method of claim 1, wherein data describing past transactions comprises at least one of: demographics, geography, payment type, and bank type of a customer.

6. A system for transaction timing advice, the system comprising:
a memory;
a processor configured to:
process input data including transaction information;
classify, by a neural network, one or more transactions into classes using the data;
cluster, by a first machine learning model, the model fed with training data created using a feature vector, the data into one or more bins, the bins describing a number of past transactions, wherein a particular bin is associated with each class;
assign a newly seen transaction to one or more of the bins, wherein assigning a newly seen transaction includes using a variation of the newly seen transaction, wherein each variation has a different value than other variations for a transaction characteristic, but the same values as other variations for other transaction characteristics;
for each of the bins, calculate, by a second machine learning model, a probability statistic of transaction success, the machine learning model incorporating details not specified by the bins;
select one or more of the bins based on a transaction value of the newly seen transaction and the probability statistic of the corresponding bin;
transmit to a computer separate from the processor, transaction timing advice, the timing advice including a characteristic of one or more of the selected bins and representing an optimal time for the processing of the newly seen transaction;
produce a recalculated timing advice, the producing triggered by one or more changes to the input data; and
if the recalculated timing advice is different than the transaction timing advice, inform a computer separate from the processor;
wherein a plurality of pending transactions are collected and processed in batches for the timing advice.

7. The system of claim 6, wherein the probability statistic is calculated as the ratio of a number of successful past transactions in a bin to a total number of transactions in the bin, wherein the total number of transactions is a sum of failed and successful transactions.

8. The system of claim 6, wherein the selection of the bin is further based on an expected value of failure of the transaction, the expected value of failure calculated as a cost of failure multiplied by a probability of failure.

9. (canceled)

10. The system of claim 6, wherein data describing past transactions comprises at least one of: demographics, geography, payment type, and bank type of a customer.

11. A computer-implemented method for transaction timing comprising:
processing, by a processor, input data including transaction information;
classifying, by a neural network, one or more transactions into classes using the data;
clustering, by a first machine learning model, the model fed with training data created using a feature vector, the data into one or more bins, the bins describing a number of past transactions, wherein a particular bin is associated with each class;
assigning, by the processor, each transaction in a plurality of transactions to one or more of the bins, each bin defined by a plurality of transaction characteristics, each bin associated with a probability of success;
assigning, by the processor, each of a plurality of variations of a new transaction a bin, wherein each variation has a different value than other variations for a transaction characteristic, but the same values as other variations for other transaction characteristics;
for each of the bins, calculating, by a second machine learning model, a probability statistic of transaction success, the machine learning model incorporating details not specified by the bins;
selecting, by the processor, the bin holding a variation of the new transaction having a highest bin value for the new transaction, the bin value calculated based on the probability statistic;
returning the transaction characteristic corresponding to the selected bin as a transaction timing advice;
producing, by the processor, a recalculated timing advice, the producing triggered by one or more changes to the input data; and
if the recalculated timing advice is different than the transaction timing advice, informing, by the processor, a computer separate from the processor;
wherein a plurality of pending transactions are collected and processed in batches for the timing advice.

12. The computer-implemented method of claim 11, wherein the probability of success is calculated as the ratio of a number of successful past transactions in a bin to a total number of transactions in the bin, wherein the total number of transactions is a sum of failed and successful transactions.

13. The computer-implemented method of claim 11, wherein selecting the bin with the highest bin value is based on an expected value of failure of the transaction, the expected value of failure calculated as a cost of failure multiplied by a probability of failure.

14. (canceled)

15. The computer-implemented method of claim 11, wherein transaction characteristics comprises at least one of: demographics, geography, payment type, and bank type of a customer.

16. A computer-implemented method for determining transaction timing, the method comprising:
processing input data including transaction information;
training a first machine learning model using a plurality of transactions each having a plurality of transaction characteristics, the characteristics for each transaction comprising a transaction success;
clustering, by the first machine learning model, the model fed with training data created using a feature vector, the data into one or more bins, the bins describing a number of past transactions, wherein a particular bin is associated with each class;
creating a plurality of variations of a new transaction;
for each of the plurality of variations of the new transactions, providing the variation of the new transaction to a second machine learning model to produce a transaction success value for the variation of the new transaction;
based on the plurality of transaction success values, determining a recommended timing for the new transaction based on a timing advice, the timing advice including a characteristic of one or more selected bins and representing an optimal time for the processing of the newly seen transaction.
Producing a recalculated timing advice, the producing triggered by one or more changes to the input data; and
if the recalculated timing advice is different than the transaction timing advice, informing a remote computer;
wherein a plurality of pending transactions are collected and processed in batches for the timing advice.

17. The computer-implemented method of claim 16, wherein the transaction success value is the ratio of a number of successful transactions to a total number of transactions.

18. The computer-implemented method of claim 16, wherein each of the plurality of variations of the new transaction comprises a different timing characteristic.

19. The computer-implemented method of claim 16, comprising displaying the recommended timing for the new transaction.

20. The computer-implemented method of claim 16, wherein transaction characteristics comprises at least one of: demographics, geography, payment type, and bank type of a customer.
